(19) United States
(12) Patent Application Publication
(10) Pub. No.: US 2024/0380876 A1
(43) Pub. Date: Nov. 14, 2024

(54) INFORMATION PROCESSING APPARATUS, INFORMATION PROCESSING METHOD, AND PROGRAM

(71) Applicant: Sony Group Corporation, Tokyo (JP)

(72) Inventors: Kazuki YOKOYAMA, Kanagawa (JP); Ruri OYA, Kanagawa (JP); Koji AOYAMA, Saitama (JP)

(73) Assignee: Sony Group Corporation, Tokyo (JP)

(21) Appl. No.: 18/285,151

(22) PCT Filed: Jan. 28, 2022
(86) PCT No.: PCT/JP2022/003278

§ 371 Date: Sep. 29, 2023

(30) Foreign Application Priority Data
Apr. 12, 2021 (JP) 2021-067159

(51) Int. Cl. H04N 13/383; H04N 13/117; H04N 13/156; H04N 13/31

(52) U.S. Cl. CPC H04N 13/383; H04N 13/117; H04N 13/156; H04N 13/31

(57) ABSTRACT

An information processing apparatus (10) includes a display generation unit (53), an eye-attracting area detection unit (51), a map generation unit (52), an image correction unit (54), and a display control unit (55). The display generation unit (53) generates a plurality of viewpoint images to be displayed as a stereoscopic image. The eye-attracting area detection unit (51) detects an eye-attracting area of a virtual space to which visual attention of a user needs to attracted. The map generation unit (52) generates a control map indicating a distribution of the degree of eye-attractiveness in a viewpoint image per viewpoint image based on the distance from the eye-attracting area. The image correction unit (54) adjusts the degree of eye-attractiveness of the viewpoint image based on the control map. The display control unit (55) displays the stereoscopic image in the virtual space using the plurality of viewpoint images whose degrees of attractiveness have been adjusted.

### FIELD

The present disclosure relates to an information processing apparatus, an information processing method, and a program.

### BACKGROUND

There is known a naked eye stereoscopic display that performs stereoscopic display using binocular parallax. Viewpoint images for a left eye and a right eye are supplied to the left eye and the right eye of an observer. Consequently, display showing as if a virtual object existed in front of the observer's eyes is achieved.

### CITATION LIST

### Patent Literature

Patent Literature 1: WO 2018/116580 A

### SUMMARY

### Technical Problem

Images reflected in right and left retinas are fused in an observer's brain and recognized as one stereoscopic image. Such a function of the brain is called fusion. When a correspondence between left and right images is clear, fusion is likely to occur. However, in a case where an expressed depth is large or the identical virtual objects are continuously disposed, an image range that needs to be recognized as one stereoscopic image becomes unclear, and fusion becomes difficult. The conventional naked eye stereoscopic display does not take easiness of fusion into account at all, and therefore fusion may rarely become difficult depending on display content, and visibility may lower.

Therefore, the present disclosure proposes an information processing apparatus, an information processing method, and a program that can achieve stereoscopic display that is easy to fuse.

### Solution to Problem

According to the present disclosure, an information processing apparatus is provided that comprises: a display generation unit that generates a plurality of viewpoint images to be displayed as a stereoscopic image; an eye-attracting area detection unit that detects an eye-attracting area of a virtual space to which a visual attention of a user needs to be attracted; a map generation unit that generates a control map indicating a distribution of a degree of eye-attractiveness in the viewpoint image per viewpoint image based on a distance from the eye-attracting area; an image correction unit that adjusts the degree of eye-attractiveness of the viewpoint image based on the control map; and a display control unit that displays the stereoscopic image in the virtual space using the plurality of viewpoint images whose degrees of attractiveness have been adjusted. According to the present disclosure, an information processing method in which an information process of the information processing apparatus is executed by a computer, and a program for causing the computer to execute the information process of the information processing apparatus, are provided.

### BRIEF DESCRIPTION OF DRAWINGS

FIG. 1 is a view illustrating an example of a display system.

FIG. 2 is a view illustrating a functional configuration of a display system.

FIG. 3 is a view illustrating an example of a stereoscopic image presented in a virtual space.

FIG. 4 is a view illustrating an example of a stereoscopic image presented in a virtual space.

FIG. 5 is a view illustrating a viewpoint image showing a stereoscopic image from a specific viewpoint.

FIG. 6 is a view for describing a flow of signal processing.

FIG. 7 is a view illustrating a distance map of a viewpoint image.

FIG. 8 is a view illustrating an example of a spatial distribution of a degree of eye-attractiveness.

FIG. 9 is a view illustrating an example of a spatial distribution of the degree of eye-attractiveness.

FIG. 10 is a view illustrating an example of a spatial distribution of the degree of eye-attractiveness.

FIG. 11 is a view illustrating an example of a control map.

FIG. 12 is a view illustrating a variation of a spatial distribution of the degree of eye-attractiveness.

FIG. 13 is a view illustrating a variation of the spatial distribution of the degree of eye-attractiveness.

FIG. 14 is a view illustrating a variation of the spatial distribution of the degree of eye-attractiveness.

FIG. 15 is a view illustrating a specific example of correction signal processing.

FIG. 16 is a view illustrating a specific example of correction signal processing.

FIG. 17 is a view illustrating a specific example of the correction signal processing.

FIG. 18 is a view illustrating a modification of the correction signal processing.

FIG. 19 is a view illustrating a hardware configuration example of the display system.

### DESCRIPTION OF EMBODIMENTS

Hereinafter, an embodiment of the present disclosure will be described in detail with reference to the drawings. Note that, in the following embodiment, the same components will be assigned the same reference numerals, and redundant description will be omitted.

Note that the description will be given in the following order.
[1. Configuration of Display System]
[2. Specific Example of Stereoscopic Image]
[3. Information Processing Method]
[3-1. Generation of Distance Map]
[3-2. Settings of Spatial Distribution of Degree of Eye-Attractiveness]
[3-3. Generation and Correction Processing of Control Map]
[3-4. Variation of Spatial Distribution of Degree of Eye-Attractiveness]
[3-5. Specific Example of Correction Signal Processing]
[4. Modification]
[5. Hardware Configuration Example]
[6. Effects]

### 1. Configuration of Display System

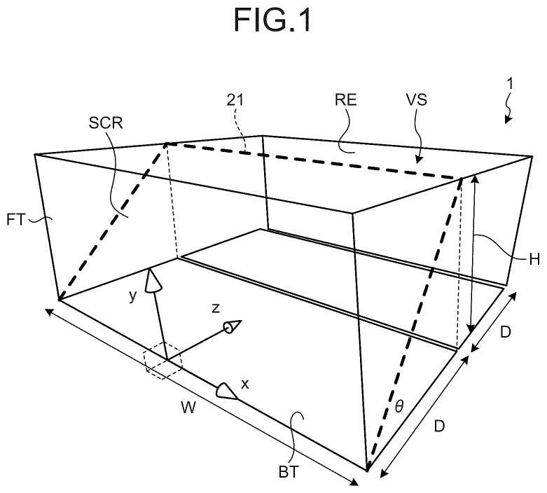

FIG. 1 is a view illustrating an example of a display system 1.

The display system 1 includes a display 21 that includes a screen SCR inclined at an angle θ with respect to a horizontal plane BT. The angle θ is, for example, 45 degrees. Hereinafter, a direction parallel to the lower side of the screen SCR is an x direction. A direction in the horizontal plane BT perpendicular to the lower side is a z direction. A direction (vertical direction) perpendicular to the x direction and the z direction is a y direction.

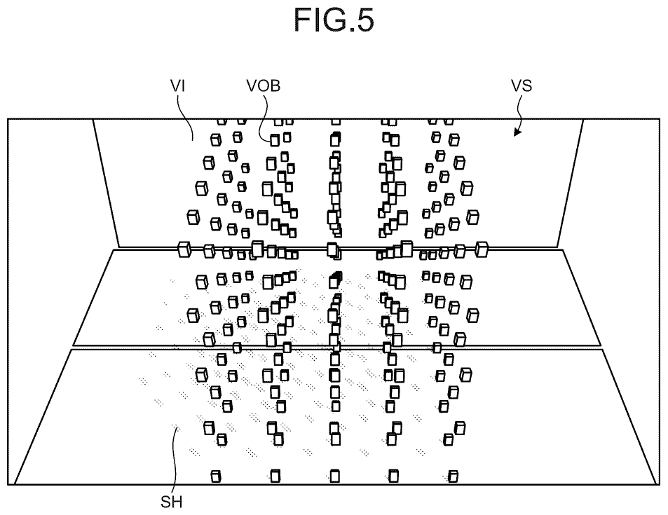

In the example of FIG. 1, the size in the x direction of the screen SCR is W, the size in the z direction is D, and the size in the y direction is H. A space of a cuboid whose sizes in the x direction, the y direction, and the z direction are W, 2×D, and H is a virtual space VS. A plurality of viewpoint images VI (see FIG. 5) displayed on the screen SCR are presented in the virtual space VS as a stereoscopic image. Hereinafter, a vertical plane of the virtual space VS on the front side of the screen SCR seen from a user (observer) is referred to as a front surface FT, and a vertical plane of the virtual space VS on the back side of the screen SCR is referred to as a rear surface RE.

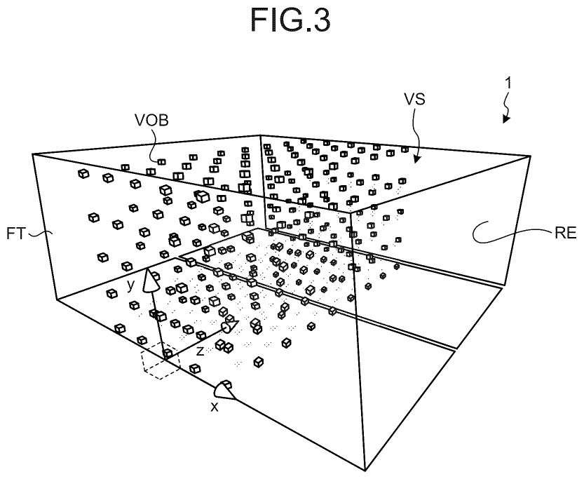

In the display system 1 that uses binocular parallax, the viewpoint images VI reflected in the left and right eyes of the user are fused and recognized as one stereoscopic image. However, in a case where a virtual object VOB (see FIG. 3) greatly pops out from the screen SCR or is disposed at a deep depth position, or in a case where the identical virtual objects VOB are continuously disposed, there is a case where an image range that needs to be recognized as one stereoscopic image is unclear. In such a case, fusion may rarely become difficult, and visibility may lower.

To view a real object, a position in a depth direction of the real object can be searched for by adjusting a focus of eyes. Consequently, it is possible to recognize a correspondence between left and right images using the position in the depth direction as a clue. However, what is actually observed on a naked eye stereoscopic display is a stereoscopic optical illusion image (viewpoint image VI) displayed on the screen SCR. A focal position of the optical illusion image is fixed on the screen SCR that serves as a light source. Therefore, the depth of the virtual object VOB cannot be searched for by adjusting the focus of the eye. This makes fusion more difficult.

In order to solve such a problem, the present disclosure proposes a method for setting a specific area in the virtual space VS as an eye-attracting area RA (see FIG. 8), and performing correction signal processing such that that the eye-attracting area RA becomes more conspicuous than other areas. By guiding a visual line ES (see FIG. 8) of the user to the eye-attracting area RA, it is easy to specify an image range that needs to be recognized as one stereoscopic image. As a result, fusion is promoted. Details will be described below.

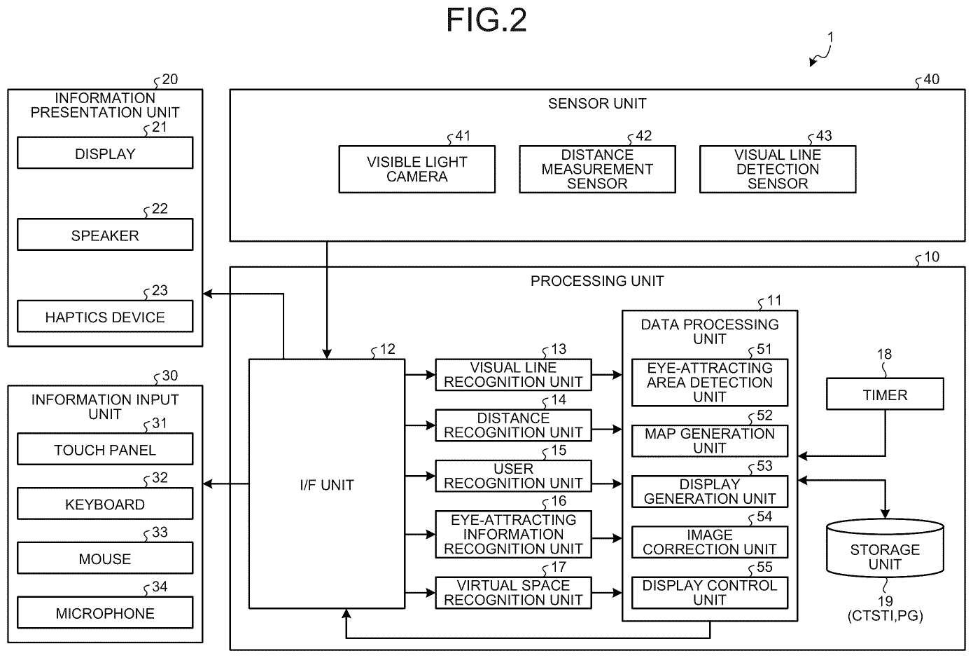

FIG. 2 is a view illustrating a functional configuration of the display system 1.

The display system 1 includes a processing unit 10, an information presentation unit 20, an information input unit 30, and a sensor unit 40. The processing unit 10 is an information processing apparatus that processes various pieces of information. The processing unit 10 controls the information presentation unit 20 based on sensor information acquired from the sensor unit 40 and user input information acquired from the information input unit 30.

The sensor unit 40 includes a plurality of sensors for sensing an outside world. The plurality of sensors include, for example, a visible light camera 41, a distance measurement sensor 42, a visual line detection sensor 43, and the like. The visible light camera 41 captures a visible light image of the outside world. The distance measurement sensor 42 detects a distance of a real object existing in the outside world using a flight time of laser light or the like. The visual line detection sensor 43 detects the visual line ES of the user directed to a display 21 using a known eye tracking technology.

The information presentation unit 20 presents various pieces of information such as video information, audio information, and tactile sense information to the user. The information presentation unit 20 includes, for example, the display 21, a speaker 22, and a haptics device 23. As the display 21, a known display such as a Liquid Crystal Display (LCD) or an Organic Light-Emitting Diode (OLED) is used. As the speaker 22, a known speaker that can output sound or the like is used. As the haptics device 23, a known haptics device that can present tactile sense information associated with display information by ultrasonic waves or the like is used.

The information input unit 30 includes a plurality of input devices that can input various pieces of information by a user's input operation. The plurality of input devices include, for example, a touch panel 31, a keyboard 32, a mouse 33, and a microphone 34.

The processing unit 10 includes, for example, a data processing unit 11, an I/F unit 12, a visual line recognition unit 13, a distance recognition unit 14, a user recognition unit 15, an eye-attracting information recognition unit 16, a virtual space recognition unit 17, a timer 18, and a storage unit 19. The processing unit 10 acquires sensor information detected by the sensor unit 40 and user input information input from the information input unit 30 via the I/F unit 12.

The visual line recognition unit 13 generates visual line information of the user who directs the visual line ES to the display 21 based on the information detected by the visual line detection sensor 43. The visual line information includes information on the positions of the eyes (viewpoint VP: see FIG. 8) and the direction of the visual line ES of the user. A known eye tracking technique is used for visual line recognition processing.

The distance recognition unit 14 generates distance information of the real object existing in the outside world based on information detected by the distance measurement sensor 42. The distance information includes, for example, information of the distance between the real object and the display 21.

The user recognition unit 15 extracts an image of the user who directs the visual line ES to the display 21 from the visible light image captured by the visible light camera 41. The user recognition unit 15 generates motion information of the user based on the extracted image of the user. The motion information includes, for example, information on a situation of work or a gesture that the user is performing while looking at the display 21.

The eye-attracting information recognition unit 16 generates eye-attracting information of the virtual space VS based on the user input information, the sensor information, and content data CT. The eye-attracting information includes information on an object or a place (eye-attracting area RA) to which the user's visual attention needs to be attracted. The eye-attracting information is used to specify position information of the eye-attracting area RA that serves as a key.

For example, in a general display mode that a main object is disposed on a front side (a side close to a user), information for specifying the object on the front side is generated as the eye-attracting information. In a case where the content data CT includes information of an eye-attracting position (an object or a place) designated by a content creator, information of the eye-attracting position extracted from the content data CT is generated as the eye-attracting information. In a case where the user is continuously gazing at a specific position, information on the gazing position of the user is generated as the eye-attracting information. In a case where, for example, a situation that the user inserts a finger, a pen, or the like into the virtual space VS and performs some work of, for example, drawing or shaping the virtual object VOB is detected from the sensor information, position information of a work portion (gazing position) is generated as the eye-attracting information.

The virtual space recognition unit 17 generates virtual space information on the virtual space VS. The virtual space information includes, for example, information on the angle θ of the screen SCR and the position and size of the virtual space VS.

The data processing unit 11 synchronizes and drives the information presentation unit 20 and the sensor unit 40 based on a timing signal generated by the timer 18. The data processing unit 11 controls the information presentation unit 20 to display in the virtual space VS a stereoscopic image whose degree of eye-attractiveness (conspicuousness) has been adjusted according to the distance from the eye-attracting area. The data processing unit 11 includes, for example, an eye-attracting area detection unit 51, a map generation unit 52, a display generation unit 53, an image correction unit 54, and a display control unit 55.

The display generation unit 53 generates the plurality of viewpoint images VI to be displayed as a stereoscopic image. The viewpoint image VI means a two-dimensional image seen from the one viewpoint VP. The plurality of viewpoint images VI include a left eye image seen from the user's left eye, and a right eye image seen from the user's right eye.

For example, the display generation unit 53 detects the position and size of the virtual space VS based on the virtual space information acquired from the virtual space recognition unit 17. The display generation unit 53 detects the positions (viewpoint VP) of the user's left eye and right eye based on the visual line information acquired from the visual line recognition unit 13. The display generation unit 53 extracts 3D data from the content data CT, and generates the viewpoint image VI by rendering the extracted 3D data based on the user's viewpoint.

The eye-attracting area detection unit 51 detects the eye-attracting area RA of the virtual space VS to which the user's visual attention needs to be attracted, based on the eye-attracting information acquired from the eye-attracting information recognition unit 16. The eye-attracting area RA is, for example, the specific virtual object VOB presented in the virtual space VS or a local area in the virtual space VS including the specific virtual object VOB. The eye-attracting area RA is detected based on, for example, the user input information, the gazing position of the user, or the eye-attracting position extracted from the content data CT. The gazing position of the user is detected based on, for example, motion information of the user acquired from the user recognition unit 15.

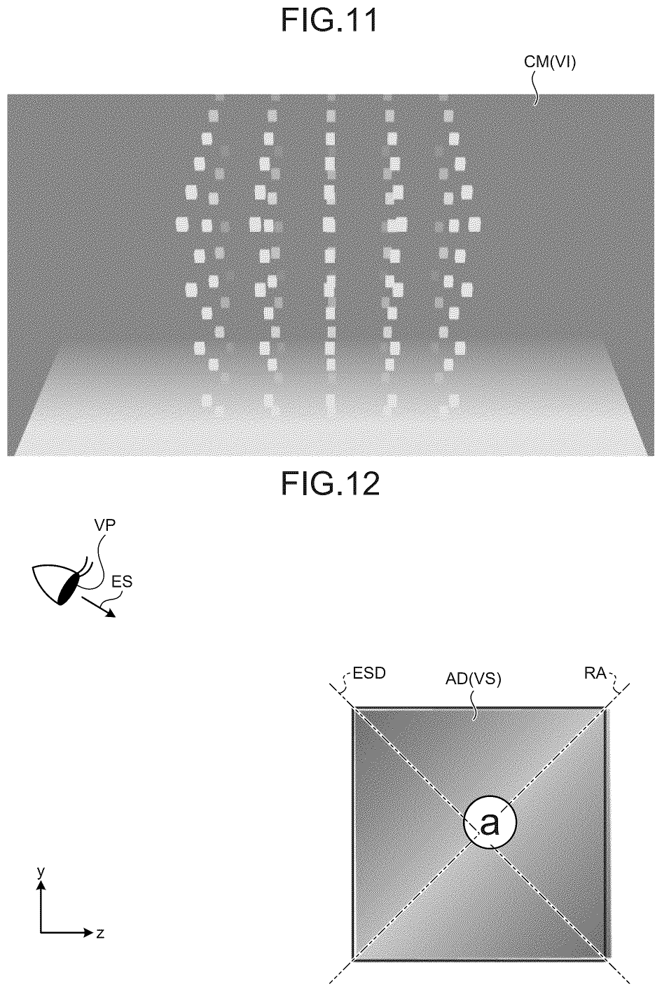

The map generation unit 52 generates a control map CM (see FIG. 11) per viewpoint image VI based on the distance from the eye-attracting area RA. The control map CM indicates a distribution of degrees of attractiveness in the viewpoint image VI. A spatial distribution of the degree of eye-attractiveness is set to the virtual space VS such that the degree of eye-attractiveness is the largest in the eye-attracting area RA.

For example, such a distribution of the degrees of attractiveness that the degree of eye-attractiveness becomes lower as the distance is more distant from the eye-attracting area RA is defined for the control map CM. The degree of eye-attractiveness is calculated using the distance from the eye-attracting area RA as a reference. The distance that serves as the reference may be a distance in the depth direction, or a distance in a direction perpendicular to the depth direction. The depth direction may be the user's visual line direction or may be the z direction. The distance from the eye-attracting area RA is calculated based on the distance information acquired from the distance recognition unit 14.

The image correction unit 54 adjusts the degree of eye-attractiveness of the viewpoint image VI based on the control map CM. For example, the image correction unit 54 adjusts the degree of eye-attractiveness of the viewpoint image VI by adjusting frequency characteristics, brightness, saturation, a contrast, transparency, or a hue of the viewpoint image VI per pixel.

For example, the image correction unit 54 maximizes characteristics such as the frequency characteristics, the brightness, the saturation, the contrast, and the transparency in the eye-attracting area RA. As a result, the eye-attracting area RA becomes prominent, and the degree of eye-attractiveness increases. In a case where the plurality of virtual objects VOB having the same hue are presented in the virtual space VS, the image correction unit 54 can make the hue of the virtual object VOB presented in the eye-attracting area RA different from the hues of the virtual objects VOB in other areas. The virtual object VOB having the hue adjusted is identified as the heterogeneous virtual object VOB from the other virtual objects VOB. Therefore, the degree of eye-attractiveness of the virtual object VOB in the eye-attracting area RA increases.

The degree of eye-attractiveness is adjusted per area by the above-described image processing. Consequently, even when homogeneous edges or textures are continuously disposed, a different edge or texture is easily perceived. As a result, fusion is promoted, and display with high visibility is achieved. The visibility is improved, so that a large depth can be expressed, and a stereoscopic effect to be perceived also improves. Furthermore, although difficulty of fusion causes visual fatigue, this visual fatigue is eliminated, so that reduction of the visual fatigue can also be expected.

The display control unit 55 displays a stereoscopic image in the virtual space VS using the plurality of viewpoint images VI whose degrees of attractiveness have been adjusted.

Information on settings, conditions, and criteria used for various arithmetic operations is included in setting information STI. The content data CT, the setting information STI, and a program PG used for the above-described processing are stored in the storage unit 19. The program PG is a program that causes a computer to execute information processing according to the present embodiment. The processing unit 10 performs various processing according to the program PG stored in the storage unit 19. The storage unit 19 may be used as a working area for temporarily storing a processing result of the processing unit 10. The storage unit 19 includes, for example, an arbitrary non-transitory storage medium such as a semiconductor storage medium and a magnetic storage medium. The storage unit 19 includes, for example, an optical disk, a magneto-optical disk, or a flash memory. The program PG is stored in, for example, a non-transitory computer-readable storage medium.

The processing unit 10 is, for example, a computer including a processor and a memory. The memory of the processing unit 10 includes a Random Access Memory (RAM) and a Read Only Memory (ROM). By executing the program PG, the processing unit 10 functions as the data processing unit 11, the I/F unit 12, the visual line recognition unit 13, the distance recognition unit 14, the user recognition unit 15, the eye-attracting information recognition unit 16, the virtual space recognition unit 17, the timer 18, the eye-attracting area detection unit 51, the map generation unit 52, the display generation unit 53, the image correction unit 54, and the display control unit 55.

### 2. Specific Example of Stereoscopic Image

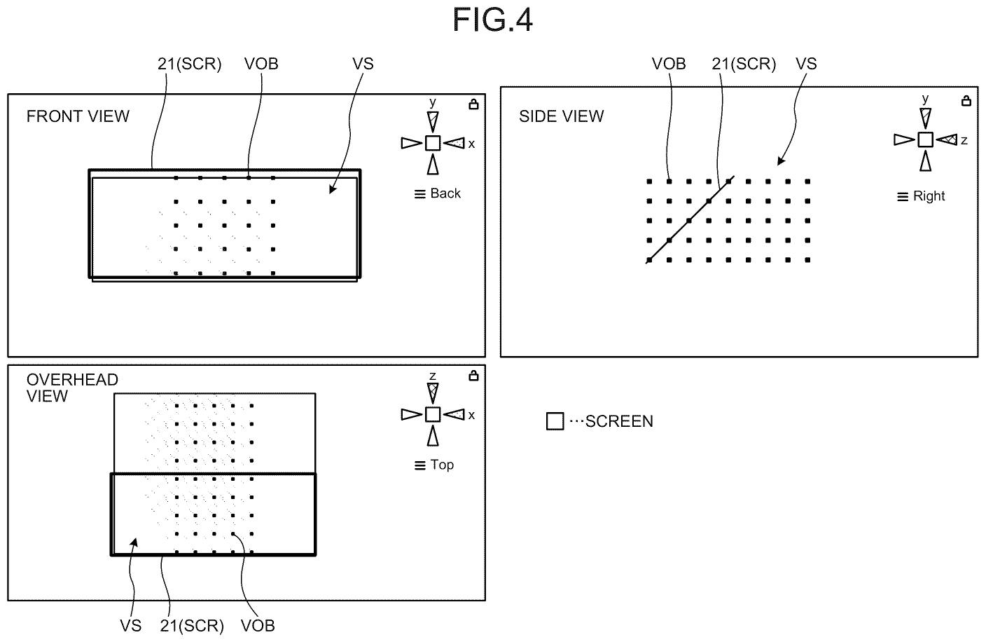

FIGS. 3 and 4 are views illustrating examples of stereoscopic images presented in the virtual space VS. FIG. 5 is a view illustrating the viewpoint image VI showing the stereoscopic image seen from the specific viewpoint VP.

The content data CT includes information on a 3D model of the stereoscopic image. By rendering the 3D model based on information of the viewpoint VP, the viewpoint image VI seen from the random viewpoint VP is generated. In the examples of FIGS. 3 to 5, the plurality of cube-shaped virtual objects VOB are periodically aligned in the x direction, the y direction, and the z direction. The plurality of virtual objects VOB are widely distributed in the z direction from the front side to the back side of the screen SCR. The viewpoint image VI includes, for example, the plurality of virtual objects VOB and shadow images SH thereof.

The user observes the stereoscopic image from the front surface FT side of the virtual space VS. Depending on an observation position, the virtual object VOB having the identical edge or texture in all directions is observed. Therefore, each one of the virtual objects VOB is difficult to distinguish, and display becomes very difficult to fuse. In order to solve this problem, in the present disclosure, a specific spatial area is made prominent to guide the user's visual line ES to this spatial area to promote fusion. Hereinafter, an example of information processing will be described.

### 3. Information Processing Method

### [3-1. Generation of Distance Map]

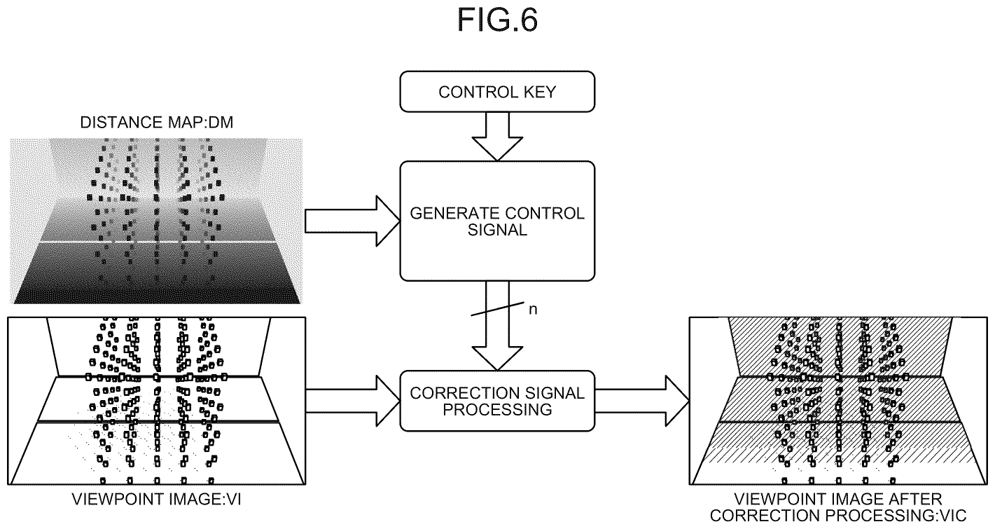

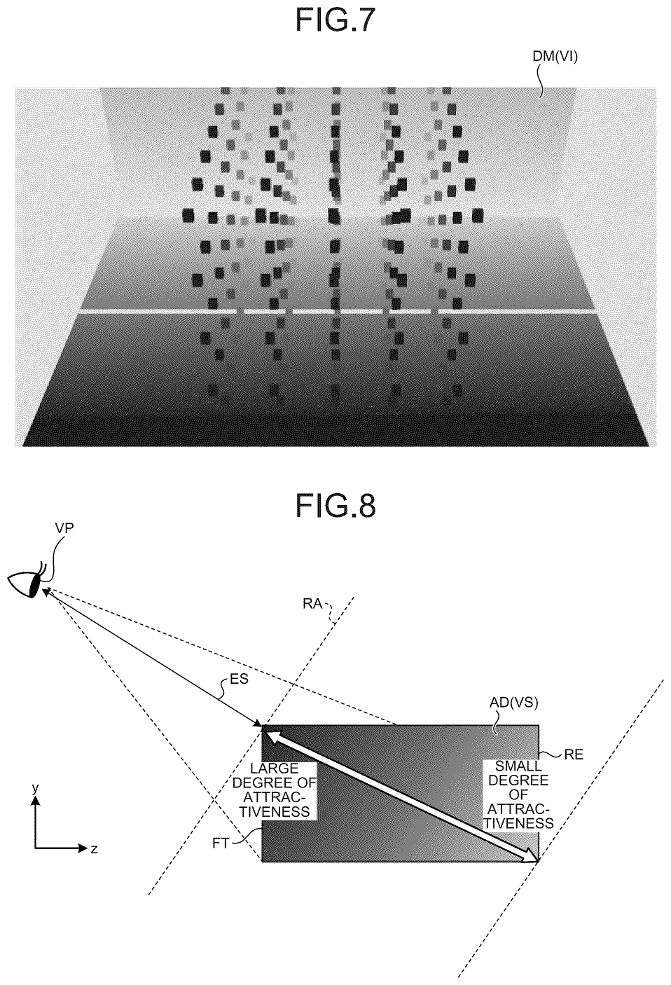

FIG. 6 is a view for describing a flow of signal processing. FIG. 7 is a view illustrating a distance map DM of the viewpoint image VI.

The map generation unit 52 generates the distance map DM of each viewpoint image VI based on three-dimensional coordinate information of the stereoscopic image. The distance map DM indicates a distribution of each distance from the viewpoint VP to the surface of the virtual object VOB. The distance map DM defines the distance from the viewpoint VP per pixel. For each pixel of the distance map DM, for example, a distance value normalized assuming that a distance to the closest position (e.g., front surface FT) in the virtual space VS seen from the user is 0 and a distance to the farthest position (e.g., rear surface RE) in the virtual space VS is 1 is defined as a pixel value.

### [3-2. Settings of Spatial Distribution of Degree of Eye-Attractiveness]

FIGS. 8 to 10 are views illustrating examples of a spatial distribution AD of the degree of eye-attractiveness.

The eye-attracting area detection unit 51 generates position information of the eye-attracting area RA based on the eye-attracting information. The eye-attracting area detection unit 51 supplies the position information of the eye-attracting area RA as a control key to the map generation unit 52. The map generation unit 52 determines the spatial distribution AD of the degree of eye-attractiveness of the virtual space VS using the position of the eye-attracting area RA as the reference. In the example of FIG. 8, the position on the virtual space VS closest to the user's viewpoint VP is determined as the eye-attracting area RA. The eye-attracting area RA is defined as a planar area perpendicular to the visual line ES. The degree of eye-attractiveness is smaller as the distance from the viewpoint VP is longer.

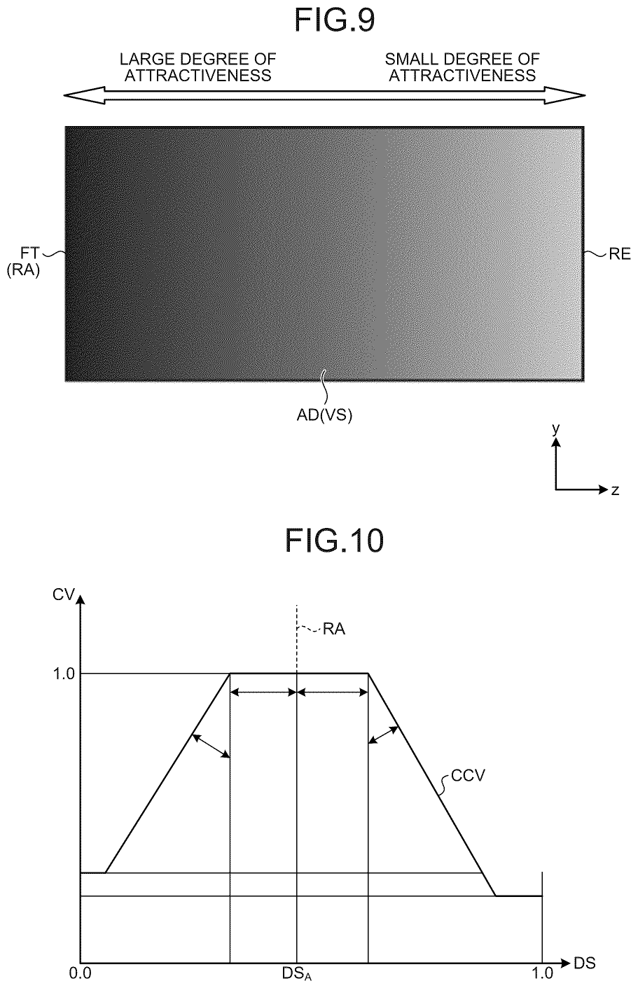

In the example of FIG. 9, the front surface FT of the virtual space VS is determined as the eye-attracting area RA. The spatial distribution AD of the degree of eye-attractiveness is set such that the degree of eye-attractiveness is smaller as the distance from the front surface FT is longer. The degree of eye-attractiveness of the rear surface RE is the smallest. In the example of FIG. 10, an area in the virtual space VS whose distance from the normalized viewpoint VP is DS_{A} is determined as the eye-attracting area RA. The map generation unit 52 determines the correction value of the image corresponding to the degree of eye-attractiveness as a control value CV. The map generation unit 52 determines a control curve CCV that defines a relationship between the distance DS and the control value CV based on the spatial distribution AD of the degree of eye-attractiveness.

### [3-3. Generation and Correction Processing of Control Map]

FIG. 11 is a view illustrating an example of the control map CM.

The map generation unit 52 generates the control map CM based on the distance map DM and the spatial distribution AD. For example, the map generation unit 52 generates the control map CM per viewpoint image VI by applying the control curve CCV to the distance map DM. The control map CM indicates a distribution of the control values CV of the corresponding viewpoint images VI. The control map CM defines the control value CV of each pixel of the viewpoint image VI. The image correction unit 54 generates a control signal for correction signal processing based on the control map CM. The image correction unit 54 corrects the viewpoint image VI using the control signal.

### [3-4. Variation of Spatial Distribution of Degree of Eye-Attractiveness]

FIGS. 12 to 14 are diagrams illustrating variations of the spatial distribution AD of the degree of eye-attractiveness.

In the example of FIG. 12, the eye-attracting area RA is set at a center part (indicated by reference symbol “a”) of the virtual space VS seen from the direction of the user's visual line ES (visual line direction ESD). A planar area at the center part of the virtual space VS perpendicular to the visual line direction ESD is the eye-attracting area RA. The degree of eye-attractiveness is the largest in the eye-attracting area RA, and the degree of eye-attractiveness gradually lowers according to the distance from the eye-attracting area RA on the front side (a side close to the user) and the back side (a side far from the user) of the eye-attracting area RA.

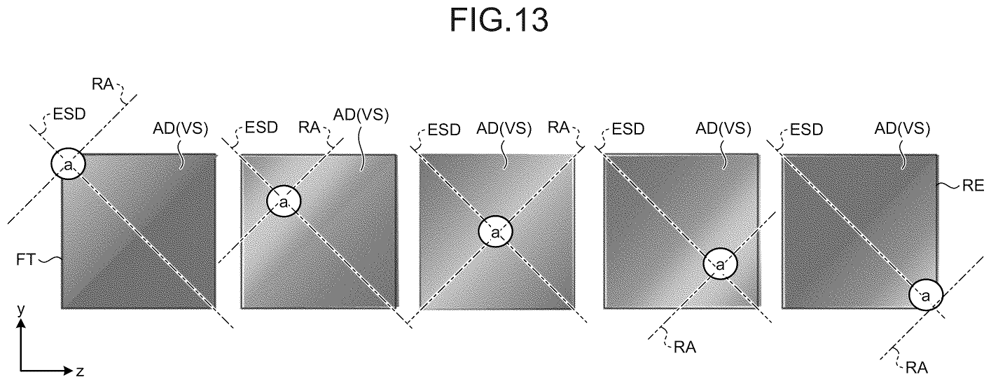

In the first example from the left in FIG. 13, the eye-attracting area RA is set at an end part on the front surface FT side of the virtual space VS seen from the visual line direction ESD. The planar area that passes the upper side of the front surface FT and is perpendicular to the visual line direction ESD is the eye-attracting area RA. The degree of eye-attractiveness is the largest in the eye-attracting area RA, and the degree of eye-attractiveness gradually lowers from the eye-attracting area RA to the center part of the virtual space VS according to the distance from the eye-attracting area RA. The degree of eye-attractiveness does not change on a back side of the center part of the virtual space VS.

In the second example from the left in FIG. 13, the eye-attracting area RA is set on the front side of the center part of the virtual space VS seen from the visual line direction ESD. The planar area perpendicular to the visual line direction ESD is the eye-attracting area RA. On the front side and the back side of the eye-attracting area RA, the degree of eye-attractiveness gradually lowers according to the distance from the eye-attracting area RA.

In the third example from the left in FIG. 13, the eye-attracting area RA is set at the center part of the virtual space VS seen from the visual line direction ESD. The spatial distribution AD of the degree of eye-attractiveness is similar to that in the example of FIG. 12.

In the fourth example from the left in FIG. 13, the eye-attracting area RA is set on a back side of the center part of the virtual space VS seen from the visual line direction ESD. The planar area perpendicular to the visual line direction ESD is the eye-attracting area RA. On the front side and the back side of the eye-attracting area RA, the degree of eye-attractiveness gradually lowers according to the distance from the eye-attracting area RA.

In the fifth example from the left in FIG. 13, the eye-attracting area RA is set at an end part on the rear surface RE side of the virtual space VS seen from the visual line direction ESD. The planar area that passes the lower side of the rear surface RE and is perpendicular to the visual line direction ESD is the eye-attracting area RA. The degree of eye-attractiveness is the largest in the eye-attracting area RA, and the degree of eye-attractiveness gradually lowers from the eye-attracting area RA to the center part of the virtual space VS according to the distance from the eye-attracting area RA. The degree of eye-attractiveness does not change on the front side of the center part of the virtual space VS.

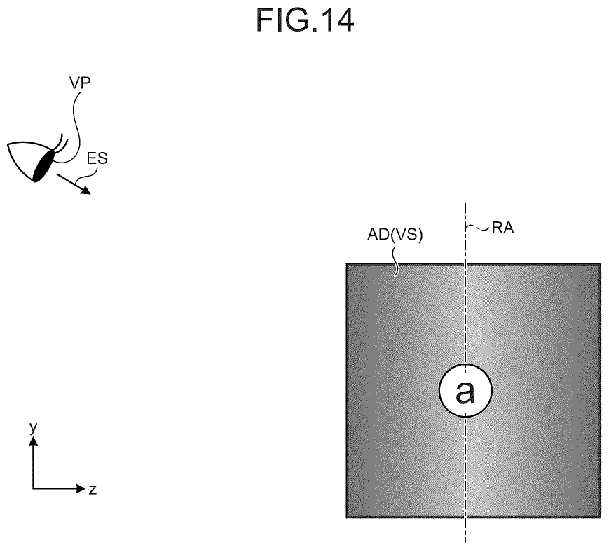

In the example of FIG. 14, the eye-attracting area RA is set at the center part of the virtual space VS seen from the z direction. The planar area at the center part of the virtual space VS perpendicular to the z direction is the eye-attracting area RA. The degree of eye-attractiveness is the largest in the eye-attracting area RA, and the degree of eye-attractiveness gradually lowers on the front side and the back side of the eye-attracting area RA according to the distance from the eye-attracting area RA.

### [3-5. Specific Example of Correction Signal Processing]

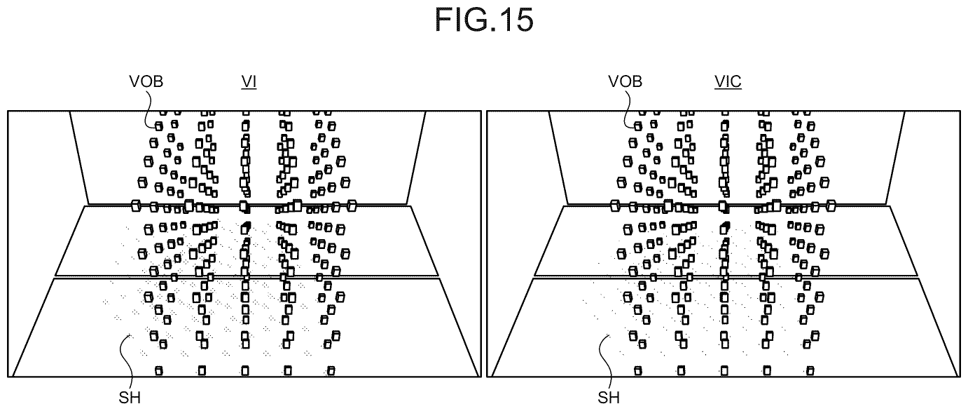

FIGS. 15 to 17 are diagrams illustrating specific examples of correction signal processing. The left side of each drawing illustrates viewpoint image VI before correction, and the right side illustrates the viewpoint image VI (corrected image VIC) after correction.

The correction signal processing is processing of adjusting the degree of eye-attractiveness of the viewpoint image VI per pixel. An object of the correction signal processing is to make an area to which eyes need to be attracted more conspicuous and make other areas inconspicuous, or to make each of the virtual objects VOB of the same type easily distinguishable and recognizable in a case where there are the multiple virtual objects VOB of the same type. According to the correction signal. processing, for example, a plurality of processing described below are performed alone or in combination.

In the example of FIG. 15, processing of increasing the frequency characteristics in an area of the high control value CV and decreasing the frequency characteristics in other parts is performed according to the control map CM. This processing increases sharpness of the main area that is the eye-attracting area RA and the virtual object VOB, and enhances visibility of the edge and the texture compared to the others. As a result, it is possible to obtain display that is easy to fuse. In the example of FIG. 15, a high degree of eye-attractiveness is set on the frontmost side seen from the visual line direction ESD. In the corrected image VIC, the sharpness on the frontmost side is higher, and the sharpness is lower toward the back side. By attracting the eyes to the front side and differing the front side from the back side at the same time, fusion is facilitated.

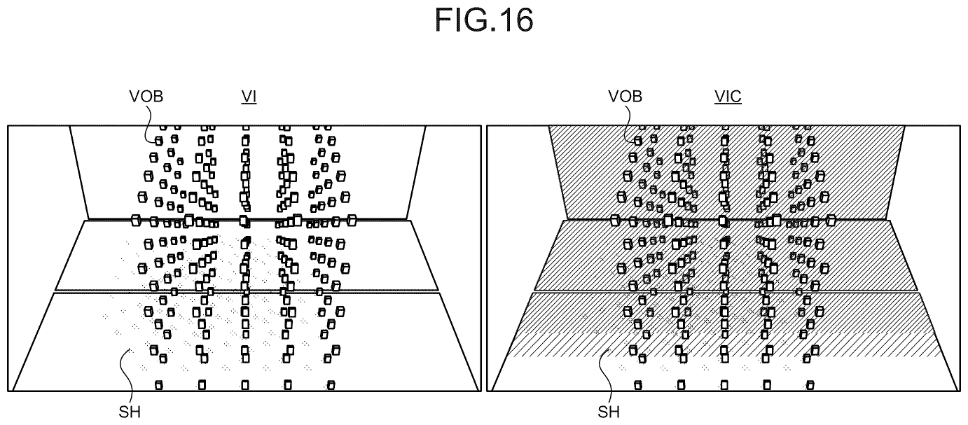

In the example of FIG. 16, processing of brightening an area of the high control value CV and darkening other parts is performed according to the control map CM. This processing makes the brightness of the main area that is the eye-attracting area RA and the virtual object VOB higher and more conspicuous than other areas. As a result, it is possible to enhance the visibility of the main area that is the eye-attracting area RA and the virtual object VOB, and obtain display that is easy to fuse. In the example of FIG. 16, a high degree of eye-attractiveness is set on the frontmost side seen from the visual line direction ESD. The corrected image VIC is brighter on the frontmost side, and is darker toward the back side. By attracting the eyes to the front side and differing the front side from the back side at the same time, fusion is facilitated.

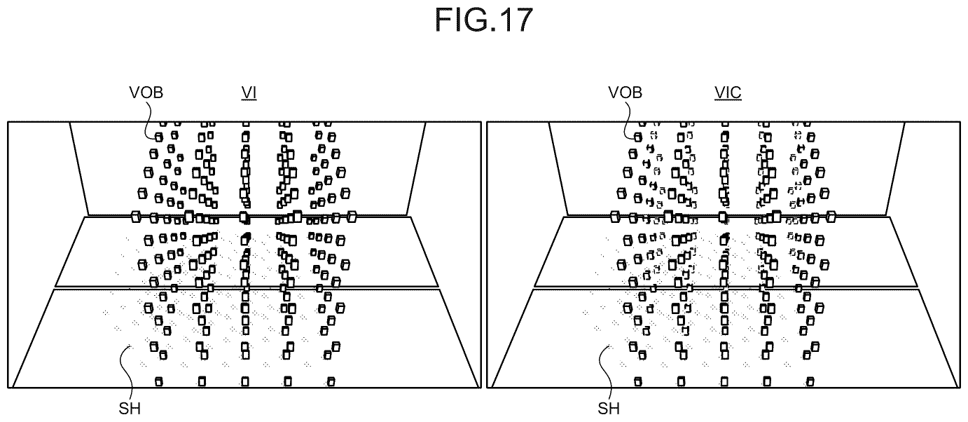

In the example of FIG. 17, processing of increasing saturation in an area of the high control value CV and decreasing the saturation in other portions is performed according to the control map CM. This processing makes the saturation of the main area that is the eye-attracting area RA and the virtual object VOB more vivid than the other portions. As a result, it is possible to enhance the visibility of the main area that is the eye-attracting area RA and the virtual object VOB, and obtain display that is easy to fuse. In the example of FIG. 17, a high degree of eye-attractiveness is set on the frontmost side seen from the visual line direction ESD. The corrected image VIC has vivid colors on the frontmost side, and has darker colors toward the back side. By attracting the eyes to the front side and differing the front side from the back side at the same time, fusion is facilitated.

Note that the correction signal processing is not limited to the above-described processing. For example, according to the control map CM, processing of increasing a local contrast of an area of the high control value CV and decreasing a contrast of other portions may be performed. The local contrast means a contrast in the virtual object VOB existing in a local space. This processing displays a texture of the main area that is the eye-attracting area RA and the virtual object VOB, and the like more vividly than the other portions. As a result, it is possible to enhance the visibility of the main area that is the eye-attracting area RA and the virtual object VOB, and obtain display that is easy to fuse.

According to the control map CM, processing of decreasing the transparency of an area of the high control value CV and increasing the transparency of other portions may be performed. This processing makes the main area that is the eye-attracting area RA and the virtual object VOB more conspicuous. As a result, it is possible to enhance the visibility of the main area that is the eye-attracting area RA and the virtual object VOB, and obtain display that is easy to fuse.

In a case where the plurality of homogeneous virtual objects VOB are presented in the virtual space VS, processing of heterogenizing the virtual object VOB per area may be performed by changing the area of the high control value CV, the hue of this area, and the like according to the control map CM. This processing makes it easy to distinguish the individual virtual objects VOB. As a result, it is possible to enhance the visibility of the main virtual object VOB that is the eye-attracting area RA, and obtain display that is easy to fuse.

### 4. Modification

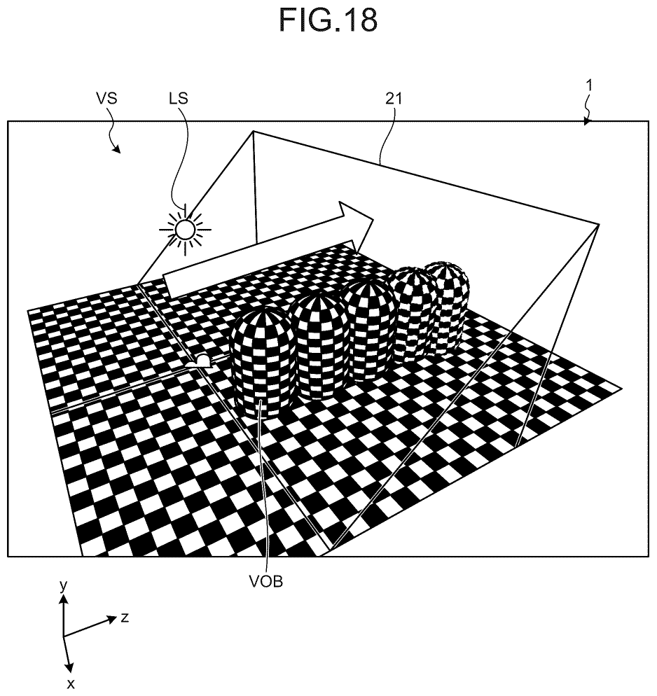

FIG. 18 is a view illustrating the modification of the correction signal processing.

The above-described correction signal processing is performed as post processing to be applied to the viewpoint image VI. However, it is also possible to achieve similar display by controlling settings of each virtual object VOB such as the material of each virtual object VOB to be drawn according to a position. For example, the image correction unit 54 extracts the plurality of virtual objects VOB from the content data CT. The image correction unit 54 adjusts the degree of eye-attractiveness of the virtual object VOB based on the alpha value corresponding to the distance between the virtual object VOB and the eye-attracting area RA per virtual object VOB.

In the example of FIG. 18, the front side seen from the z direction is defined as a main area that is the eye-attracting area RA. The alpha value of the material is lowered for the virtual object VOB on the back side, and the display having high transparency is shown. This processing makes the virtual object VOB on the front side that is the eye-attracting area RA more conspicuous. As a result, it is possible to enhance the visibility of the main virtual object VOB on the front side that is the eye-attracting area RA, and obtain display that is easy to fuse.

### 5. Hardware Configuration Example

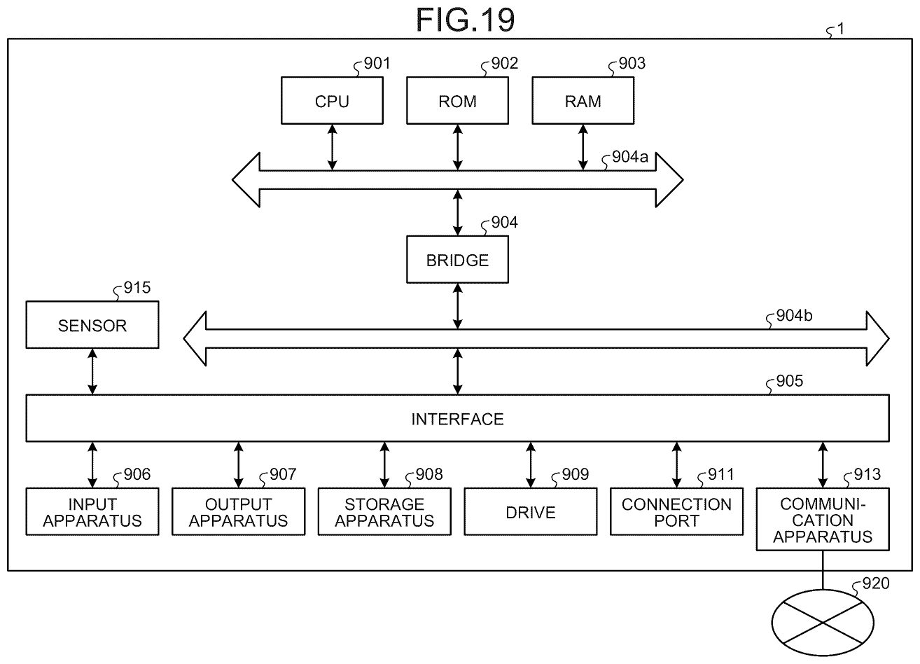

FIG. 19 is a view illustrating a hardware configuration example of the display system 1.

The display system 1 includes a Central Processing Unit (CPU) 901, a Read Only Memory (ROM) 902, a Random Access Memory (RAM) 903, and a host bus 904a. Furthermore, the display system 1 includes a bridge 904, an external bus 904b, an interface 905, an input apparatus 906, an output apparatus 907, a storage apparatus 908, a drive 909, a connection port 911, a communication apparatus 913, and a sensor 915. The display system 1 may include a processing circuit such as a DSP or an ASIC instead of or in addition to the CPU 901.

The CPU 901 functions as an arithmetic processing apparatus and a control apparatus, and controls all operations in the display system 1 according to various programs. Furthermore, the CPU 901 may be a microprocessor. The ROM 902 stores programs, operation parameters, and the like used by the CPU 901. The RAM 903 temporarily stores programs used to be executed by the CPU 901, parameters that change as appropriate at a time of the execution, and the like. The CPU 901 can implement, for example, the data processing unit 11, the visual line recognition unit 13, the distance recognition unit 14, the user recognition unit 15, the eye-attracting information recognition unit 16, and the virtual space recognition unit 17.

The CPU 901, the ROM 902, and the RAM 903 are mutually connected by the host bus 904a including a CPU bus and the like. The host bus 904a is connected to the external bus 904b such as a Peripheral Component Interconnect/Interface (PCI) bus via the bridge 904. Note that the host bus 904a, the bridge 904, and the external bus 904b do not necessarily need to be configured separately, and these functions may be implemented in one bus.

The input apparatus 906 is implemented as, for example, an apparatus to which the user inputs information such as a mouse, a keyboard, a touch panel, a button, a microphone, a switch, and a lever. Furthermore, the input apparatus 906 may be, for example, a remote control apparatus that uses infrared light or other radio waves, or may be an external connection device such as a mobile phone or a PDA that supports the operations of the display system 1. Furthermore, the input apparatus 906 may include, for example, an input control circuit that generates an input signal based on information input by the user using the above input means, and outputs the input signal to the CPU 901. The user of the display system 1 can input various items of data and instruct a processing operation to the display system 1 by operating this input apparatus 906. The input apparatus 906 can be configured as, for example, the information input unit 30.

The output apparatus 907 is configured as an apparatus that can visually or aurally notify the user of the acquired information. Examples of such an apparatus include a display apparatus such as a CRT display apparatus, a liquid crystal display apparatus, a plasma display apparatus, an EL display apparatus, and a lamp, an audio output apparatus such as a speaker and a headphone, and a printer apparatus. The output apparatus 907 outputs, for example, results obtained by various processing performed by the display system 1. More specifically, the display apparatus visually displays the results obtained by the various processing performed by the display system 1 in various formats such as texts, images, tables, and graphs. On the other hand, the audio output apparatus converts an audio signal including played-back audio data, acoustic data, or the like into an analog signal, and aurally outputs the analog signal. The output apparatus 907 can be configured as, for example, the information presentation unit 20.

The storage apparatus 908 is a data storage apparatus that is configured as an example of a storage unit of the display system 1. The storage apparatus 908 is implemented as, for example, a magnetic storage unit device such as an HDD, a semiconductor storage device, an optical storage device, a magneto-optical storage device, or the like. The storage apparatus 908 may include a storage medium, a recording apparatus that records data in the storage medium, a reading apparatus that reads data from the storage medium, a deletion apparatus that deletes data recorded in the storage medium, and the like. This storage apparatus 908 stores programs executed by the CPU 901, various data, various data acquired from the outside, and the like. The above storage apparatus 908 can be configured as, for example, the storage unit 19.

The drive 909 is a reader/writer for the storage medium, and is built in or externally attached to the display system 1. The drive 909 reads information recorded in a removable storage medium such as a mounted magnetic disk, optical disk, magneto-optical disk, or semiconductor memory, and outputs the information to the RAM 903. Furthermore, the drive 909 can also write information in the removable storage medium.

The connection port 911 is an interface that is connected to an external device, and is a connection port to connect with the external device that can transmit data via, for example, a Universal Serial Bus (USB).

The communication apparatus 913 is, for example, a communication interface configured as a communication device or the like for connecting to a network 920. The communication apparatus 913 is, for example, a communication card for a wired or wireless Local Area Network (LAN), Long Term Evolution (LTE), Bluetooth (registered trademark), a wireless USB (WUSB), or the like. Furthermore, the communication apparatus 913 may be a router for optical communication, a router for an Asymmetric Digital Subscriber Line (ADSL), a modem for various communications, or the like. For example, this communication apparatus 913 can transmit and receive signals and the like via the Internet or to and from other communication devices according to a predetermined protocol such as TCP/IP.

The sensor 915 is, for example, various sensors such as an acceleration sensor, a gyro sensor, a geomagnetic sensor, an optical sensor, a sound sensor, a distance measurement sensor, and a force sensor. The sensor 915 acquires information on a state of the display system 1 itself such as a posture and a moving speed of the display system 1, and information on surrounding environment of the display system 1 such as brightness and noise around the display system 1. Furthermore, the sensor 915 may include a GPS sensor that receives a GPS signal and measures a latitude, a longitude, and an altitude of the apparatus. The sensor 915 can be configured as, for example, the sensor unit 40.

Note that the network 920 is a wired or wireless transmission path of information transmitted from an apparatus connected to the network 920. For example, the network 920 may include a public network such as the Internet, a telephone network, or a satellite communication network, various Local Area Networks (LANs) including the Ethernet (registered trademark), a Wide Area Network (WAN), or the like. Furthermore, the network 920 may include dedicated line networks such as an Internet Protocol-Virtual Private Network (IP-VPN).

### 6. Effects

The processing unit 10 includes the display generation unit 53, the eye-attracting area detection unit 51, the map generation unit 52, the image correction unit 54, and the display control unit 55. The display generation unit 53 generates the plurality of viewpoint images VI to be displayed as a stereoscopic image. The eye-attracting area detection unit 51 detects the eye-attracting area RA of the virtual space VS to which user's visual attention needs to be attracted. The map generation unit 52 generates the control map CM indicating the distribution of the degree of eye-attractiveness in the viewpoint image VI per viewpoint image VI based on the distance from the eye-attracting area RA. The image correction unit 54 adjusts the degree of eye-attractiveness of the viewpoint image VI based on the control map CM. The display control unit 55 displays a stereoscopic image in the virtual space VS using the plurality of viewpoint images VI whose degrees of attractiveness have been adjusted. According to the information processing method of the present embodiment, the processing of the above-described processing unit 10 is executed by the computer. The program according to the present embodiment causes the computer to implement the processing of the above-described processing unit 10.

According to this configuration, it is possible to attract an observer's gaze to an image area that needs to be recognized as one stereoscopic image. Consequently, fusion easily occurs.

The control map CM defines such a distribution of the degree of eye-attractiveness that the degree of eye-attractiveness becomes lower as the distance apart from the eye-attracting area RA is more distant.

According to this configuration, the eye-attracting area RA becomes conspicuous compared to other areas. Consequently, fusion is promoted.

The map generation unit 52 generates the distance map DM of each viewpoint image VI based on three-dimensional coordinate information of the stereoscopic image. The map generation unit 52 determines the spatial distribution AD of the degree of eye-attractiveness of the virtual space VS using the position of the eye-attracting area RA as the reference. The map generation unit 52 generates the control map CM based on the distance map DM and the spatial distribution AD of the degree of eye-attractiveness.

According to this configuration, the control map CM is easily generated based on three-dimensional coordinate information of the stereoscopic image.

The image correction unit 54 adjusts the degree of eye-attractiveness of the viewpoint image VI by adjusting frequency characteristics, brightness, saturation, a contrast, transparency, or a hue of the viewpoint image VI per pixel.

According to this configuration, it is easy to attract the observer's gaze to the eye-attracting area RA.

The image correction unit 54 extracts the plurality of virtual objects VOB from the content data CT. The image correction unit 54 adjusts the degree of eye-attractiveness of the virtual object VOB based on the alpha value corresponding to the distance between the virtual object VOB and the eye-attracting area RA per virtual object VOB.

According to this configuration, it is easy to attract the observer's gaze to the eye-attracting area RA.

The eye-attracting area detection unit 51 detects the eye-attracting area RA based on the user input information, the gazing position of the user, or the eye-attracting position extracted from the content data CT.

According to this configuration, the eye-attracting area RA is appropriately set.

Note that the effects described in the description are merely examples and are not limited, and other effects may be provided.

### Supplementary Note

Note that the present technique can also employ the following configurations.

(1)

An information processing apparatus comprising:
a display generation unit that generates a plurality of viewpoint images to be displayed as a stereoscopic image;
an eye-attracting area detection unit that detects an eye-attracting area of a virtual space to which a visual attention of a user needs to be attracted;
a map generation unit that generates a control map indicating a distribution of a degree of eye-attractiveness in the viewpoint image per viewpoint image based on a distance from the eye-attracting area;
an image correction unit that adjusts the degree of eye-attractiveness of the viewpoint image based on the control map; and
a display control unit that displays the stereoscopic image in the virtual space using the plurality of viewpoint images whose degrees of attractiveness have been adjusted.
   (2)

The information processing apparatus according to (1), wherein
the control map defines such a distribution of the degree of eye-attractiveness that the degree of eye-attractiveness becomes lower as the distance from the eye-attracting area is more distant.
   (3)

The information processing apparatus according to (1) or (2), wherein
the map generation unit generates a distance map of each viewpoint image based on three-dimensional coordinate information of the stereoscopic image, determines a spatial distribution of a degree of eye-attractiveness of the virtual space using a position of the eye-attracting area as a reference, and generates the control map based on the distance map and the spatial distribution of the degree of eye-attractiveness.
   (4)

The information processing apparatus according to any one of (1) to (3), wherein
the image correction unit adjusts the degree of eye-attractiveness of the viewpoint image by adjusting frequency characteristics, brightness, saturation, a contrast, transparency, or a hue of the viewpoint image per pixel.
   (5)

The information processing apparatus according to any one of (1) to (3), wherein
the image correction unit extracts a plurality of virtual objects from content data, and adjusts a degree of eye-attractiveness of each of the virtual objects based on an alpha value corresponding to a distance between the virtual object and the eye-attracting area per virtual object.
   (6)

The information processing apparatus according to any one of (1) to (5), wherein
the eye-attracting area detection unit detects the eye-attracting area based on user input information, a gazing position of the user, or an eye-attracting position extracted from content data.
   (7)

An information processing method executed by a computer, comprising:
generating a plurality of viewpoint images to be displayed as a stereoscopic image;
detecting an eye-attracting area of a virtual space to which a visual attention of a user needs to be attracted;
generating a control map indicating a distribution of a degree of eye-attractiveness in the viewpoint image per viewpoint image based on a distance from the eye-attracting area;
adjusting the degree of eye-attractiveness of the viewpoint image based on the control map; and
displaying the stereoscopic image in the virtual space using the plurality of viewpoint images whose degrees of attractiveness have been adjusted.
   (8)

A program causing a computer to execute:
generating a plurality of viewpoint images to be displayed as a stereoscopic image;
detecting an eye-attracting area of a virtual space to which a visual attention of a user needs to be attracted;
generating a control map indicating a distribution of a degree of eye-attractiveness in the viewpoint image per viewpoint image based on a distance from the eye-attracting area;
adjusting the degree of eye-attractiveness of the viewpoint image based on the control map; and
displaying the stereoscopic image in the virtual space using the plurality of viewpoint images whose degrees of attractiveness have been adjusted.

### REFERENCE SIGNS LIST

10 PROCESSING UNIT (INFORMATION PROCESSING APPARATUS)
51 EYE-ATTRACTING AREA DETECTION UNIT
52 MAP GENERATION UNIT
53 DISPLAY GENERATION UNIT
54 IMAGE CORRECTION UNIT
55 DISPLAY CONTROL UNIT
AD SPATIAL DISTRIBUTION OF DEGREE OF EYE-ATTRACTIVENESS
CM CONTROL MAP
CT CONTENT DATA
DM DISTANCE MAP
PG PROGRAM
RA EYE-ATTRACTING AREA
VI VIEWPOINT IMAGE
VOB VIRTUAL OBJECT
VS VIRTUAL SPACE

1. An information processing apparatus comprising:
a display generation unit that generates a plurality of viewpoint images to be displayed as a stereoscopic image;
an eye-attracting area detection unit that detects an eye-attracting area of a virtual space to which a visual attention of a user needs to be attracted;
a map generation unit that generates a control map indicating a distribution of a degree of eye-attractiveness in the viewpoint image per viewpoint image based on a distance from the eye-attracting area;
an image correction unit that adjusts the degree of eye-attractiveness of the viewpoint image based on the control map; and
a display control unit that displays the stereoscopic image in the virtual space using the plurality of viewpoint images whose degrees of attractiveness have been adjusted.

2. The information processing apparatus according to claim 1, wherein
the control map defines such a distribution of the degree of eye-attractiveness that the degree of eye-attractiveness becomes lower as the distance from the eye-attracting area is more distant.

3. The information processing apparatus according to claim 1, wherein
the map generation unit generates a distance map of each viewpoint image based on three-dimensional coordinate information of the stereoscopic image, determines a spatial distribution of a degree of eye-attractiveness of the virtual space using a position of the eye-attracting area as a reference, and generates the control map based on the distance map and the spatial distribution of the degree of eye-attractiveness.

4. The information processing apparatus according to claim 1, wherein
the image correction unit adjusts the degree of eye-attractiveness of the viewpoint image by adjusting frequency characteristics, brightness, saturation, a contrast, transparency, or a hue of the viewpoint image per pixel.

5. The information processing apparatus according to claim 1, wherein
the image correction unit extracts a plurality of virtual objects from content data, and adjusts a degree of eye-attractiveness of each of the virtual objects based on an alpha value corresponding to a distance between the virtual object and the eye-attracting area per virtual object.

6. The information processing apparatus according to claim 1, wherein
the eye-attracting area detection unit detects the eye-attracting area based on user input information, a gazing position of the user, or an eye-attracting position extracted from content data.

7. An information processing method executed by a computer, comprising:
generating a plurality of viewpoint images to be displayed as a stereoscopic image;
detecting an eye-attracting area of a virtual space to which a visual attention of a user needs to be attracted;
generating a control map indicating a distribution of a degree of eye-attractiveness in the viewpoint image per viewpoint image based on a distance from the eye-attracting area;
adjusting the degree of eye-attractiveness of the viewpoint image based on the control map; and
displaying the stereoscopic image in the virtual space using the plurality of viewpoint images whose degrees of attractiveness have been adjusted.

8. A program causing a computer to execute:
generating a plurality of viewpoint images to be displayed as a stereoscopic image;
detecting an eye-attracting area of a virtual space to which a visual attention of a user needs to be attracted;
generating a control map indicating a distribution of a degree of eye-attractiveness in the viewpoint image per viewpoint image based on a distance from the eye-attracting area;
adjusting the degree of eye-attractiveness of the viewpoint image based on the control map; and
displaying the stereoscopic image in the virtual space using the plurality of viewpoint images whose degrees of attractiveness have been adjusted.
